(19) United States
(12) Patent Application Publication
(10) Pub. No.: US 2026/0062239 A1
(43) Pub. Date: Mar. 5, 2026

(54) WASHABLE SIFTER BIN FOR TOY BUILDING BLOCKS

(71) Applicant: Travis Mongeon, Royse City, TX (US)

(72) Inventor: Travis Mongeon, Royse City, TX (US)

(21) Appl. No.: 18/825,039

(22) Filed: Sep. 5, 2024

(51) Int. Cl. B65G 65/48

(52) U.S. Cl. CPC B65G 65/4872; B65G 2201/022; B65G 2814/0223

(57) ABSTRACT

A washable sifter bin device including a circular bottom sheet having a plurality of circular holes, a cylindrical wall surrounding the circular bottom sheet, and a central knob attached to the bottom sheet and located at a center of the bottom sheet. A storage and washing sifter bins'assembly includes a plurality of washable sifter bins attachably stocked to one another, wherein each of the plurality of the washable sifter bins includes a circular bottom sheet having a plurality of circular holes of a particular diameter specified for each of the plurality of the washable sifter bins; a cylindrical wall surrounding the circular bottom sheet; and a central knob attached to the bottom sheet and located at a center of the bottom sheet.

### TECHNICAL FIELD

Embodiments of the invention relate to washing toy building blocks, and more particularly, to washable and stackable sifter bins for washing toys and toy building blocks.

### BACKGROUND

Many companies that produce toy building blocks for children instruct the parents or users to pour contents into a tub and soak them with soapy water. This is cumbersome and time consuming. Drying of the toy building blocks may also take additional time and effort. Some wooden type sifters for building blocks exist. However, these conventional devices that are easily breakable and do not allow the user to wash the contents. These wooden devices have a low life span and are not kids friendly, can be damaged, and are not easily moveable by a user. There are other smaller versions of the container for toy building blocks that are implemented in metal that do not provide the durability or the ability to wash large quantities of the contents. None of the existing device are dishwasher washable.

Accordingly, washable and stackable sifter bins for washing toys and toy building blocks are desired.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

Briefly summarized, disclosed herein is a sifter bin device consisting of a circular bottom sheet having a plurality of circular holes, a cylindrical wall surrounding the circular bottom sheet, and a central knob attached to the bottom sheet and located at a center of the bottom sheet.

In one embodiment, a storage sifter bin assembly is provided. The storage sifter bin assembly includes a plurality of washable sifter bins attachable stocked to one another. Each of the plurality of the washable sifter bins includes a circular bottom sheet having a plurality of circular holes, a cylindrical wall surrounding the circular bottom sheet and a central knob attached to the bottom sheet and located at a center of the bottom sheet.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1A illustrates an isometric view of a sifter bin assembly 100 according to the disclosed embodiments;

FIG. 1B illustrates a top view of the sifter bin assembly 100 according to the disclosed embodiments;

FIG. 1C illustrates a side view of a central knob of the sifter bin assembly 100, according to some embodiments;

FIG. 2A illustrates an isometric view of a sifter bin assembly 200 according to the disclosed embodiments according to the disclosed embodiments;

FIG. 2B illustrates a illustrates a top view of the sifter bin assembly 200 according to the disclosed embodiments;

FIG. 2C illustrates a side view of a central knob of the sifter bin assembly 200 according to some embodiments;

FIG. 3A illustrates an isometric view of a sifter bin assembly 300 according to the disclosed embodiments according to the disclosed embodiments;

FIG. 3B illustrates a illustrates a top view of the sifter bin assembly 300 according to the disclosed embodiments;

FIG. 3C illustrates a side view of a central knob of the sifter bin assembly 300 according to some embodiments;

FIG. 4A illustrates an isometric view of a sifter bin assembly 400 according to the disclosed embodiments according to the disclosed embodiments;

FIG. 4B illustrates a illustrates a top view of the sifter bin assembly 400 according to the disclosed embodiments;

FIG. 4C illustrates a side view of a central knob of the sifter bin assembly 400 according to some embodiments;

FIG. 5A illustrates an isometric view of a wash bin assembly 500 according to the disclosed embodiments according to the disclosed embodiments;

FIG. 5B illustrates a illustrates a top view of the wash bin assembly 500 according to the disclosed embodiments;

FIG. 5C illustrates a side view of plastic ball bearings of the wash bin assembly 500 according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to washable and stackable sifter bins for washing toys and toy building blocks.

The disclosed embodiments provide durability and ability to be washed in the dishwasher, while providing ease of storage for parents and children. The disclosed washable and stackable sifter bins provide for a hands-free washing by allowing the user not to touch the contents when washing, while also providing ease of washing and drying contents in a much quicker way than traditional ways discussed above in the background section.

In one embodiment, the sifter bins may be stocked on top of each other for storage. The structure may be approximately 18″ high and 14″ wide of each bin. Each sifter bin may lock into place on top of the previous sifter bin for security but also to transport contents. There are holes at the bottom of each bin, used for not only the sifting, but for drainage of the water and cleaning contents. Each bin has an element that allows these drainage holes, sifting holes and drying holes to sit above a flat surface of approximately 1″. This space allows for drying, and drainage into the wash bin which may be 16″ wide allowing each bin to click into the “spin” mechanism located in the middle of the wash bin.

As discussed above, the sifter bins system allows the user to organize numerous building blocks into different size and shape bins, locks the bins together for storage, and allows the user to unlock the bins to use for building or playing with the contents without having to dump them out onto another surface. The bins are quickly locked back together for storage and easy transfer of the contents. The disclosed sifter bins allow the users to wash the vast number of contents without having to touch or transfer the contents elsewhere. The bins also allow not only to wash, but to spin out the wash contents and drain the contents down into the wash bin to be disposed of.

As discussed above, each sifter bin is lockable to the others. The top, with a 2″ hose hole, for example, allows the user to secure the bin, wash the contents without fear of getting more wash contents on themselves. The stackable bins assembly provides grips in each bin and on the top to spin and grip the bin to help facilitate the centripetal force that assists in drying out the contents. The wash bin is novel since other bins do not provide for a mechanism to help facilitate the cleaning of the contents for sanitization. The locked bins together with top and grip cover allow the user to move, transfer the contents to other locations with ease. The separated sifter bins, when in use, allows the user of the contents to separate the contents without having to dump or pour the contents onto another location or surface (i.e., a carpet or a table). The separate bins then can be quickly reassembled for storage or transfer.

The disclosed embodiments may, advantageously, allow for washing the contents quickly and in an organized fashion, without a need to even transfer or touch the contents. The assembly allows the use to then spin each bin to allow any trapped washing substance out of the contents of the bin and to drain into the overall wash bin. The locking mechanisms may create a way to sift the contents and store them ready to be unlocked and used by end user (usually children). The bins assembly may be used as a sifter and organizer for Think Lego™.

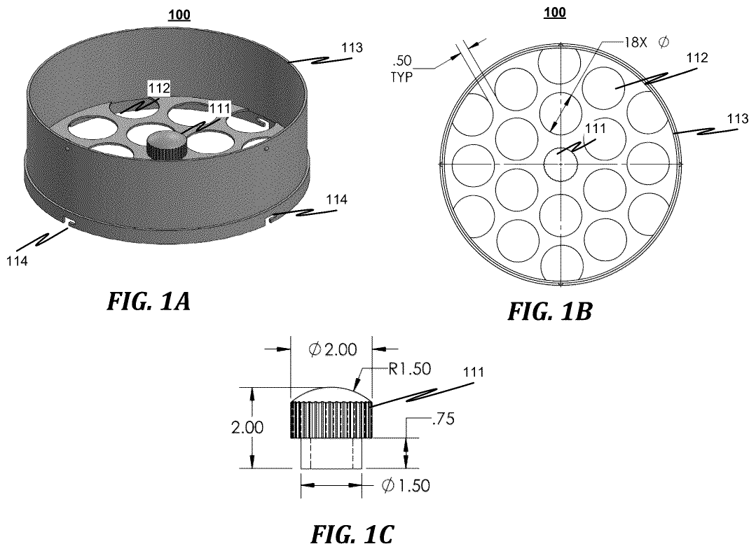

FIG. 1A illustrates an isometric view of a sifter bin assembly 100 according to the disclosed embodiments.

Referring to FIG. 1A, the sifter bin 100 has a plurality of round holes 112 located on a bottom sheet of the sifter bin 100. The bottom of the sifter bin 100 is surrounded by cylindrical wall 113. A round ring with locks 114 is attached to the lower end of the cylindrical wall 113. A central knob 111 is positioned at the center of the bottom sheet of the sifter bin 100.

FIG. 1B illustrates a top view of the sifter bin assembly 100 according to the disclosed embodiments.

Referring to FIG. 1B, the plurality of round holes 112 is located on a bottom sheet of the sifter bin 100 surrounded by the cylindrical wall 113. The central knob 111 is positioned at the center of the bottom sheet of the sifter bin 100. The sifter bin 100 assembly may have, but not limited to, dimensions depicted in FIG. 1B.

FIG. 1C illustrates a side view of a central knob of the sifter bin assembly 100 according to some embodiments.

Referring to FIG. 1C, the central knob 111 may have, but not limited to, demotions depicted in FIG. 1C.

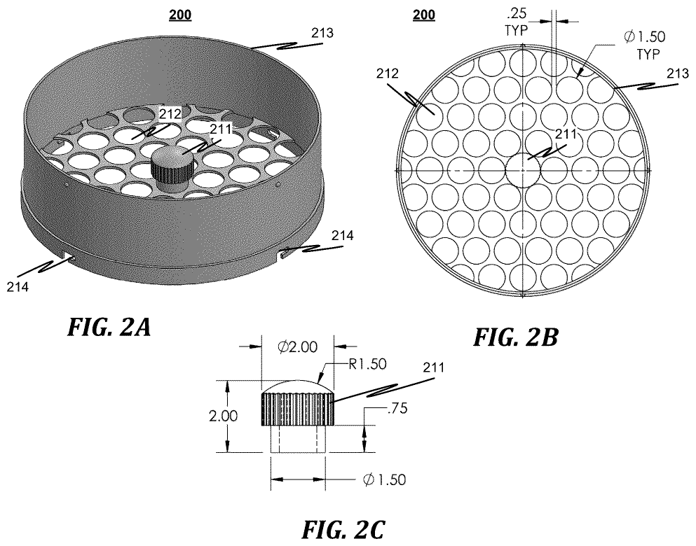

FIG. 2A illustrates an isometric view of a sifter bin assembly 200 according to the disclosed embodiments according to the disclosed embodiments.

Referring to FIG. 2A, the sifter bin 200 has a plurality of round holes 212 located on a bottom sheet of the sifter bin 200. The bottom of the sifter bin 200 is surrounded by cylindrical wall 213. A round ring with locks 214 is attached to the lower end of the cylindrical wall 213. A central knob 211 is positioned at the center of the bottom sheet of the sifter bin 200.

FIG. 2B illustrates a illustrates a top view of the sifter bin assembly 200 according to the disclosed embodiments.

Referring to FIG. 2B, the plurality of round holes 212 is located on a bottom sheet of the sifter bin 200 surrounded by the cylindrical wall 213. The central knob 211 is positioned at the center of the bottom sheet of the sifter bin 200. The sifter bin 200 assembly may have, but not limited to, dimensions depicted in FIG. 2B.

FIG. 2C illustrates a side view of a central knob of the sifter bin assembly 200 according to some embodiments. Referring to FIG. 2C, the central knob 211 may have, but not limited to, demotions depicted in FIG. 2C.

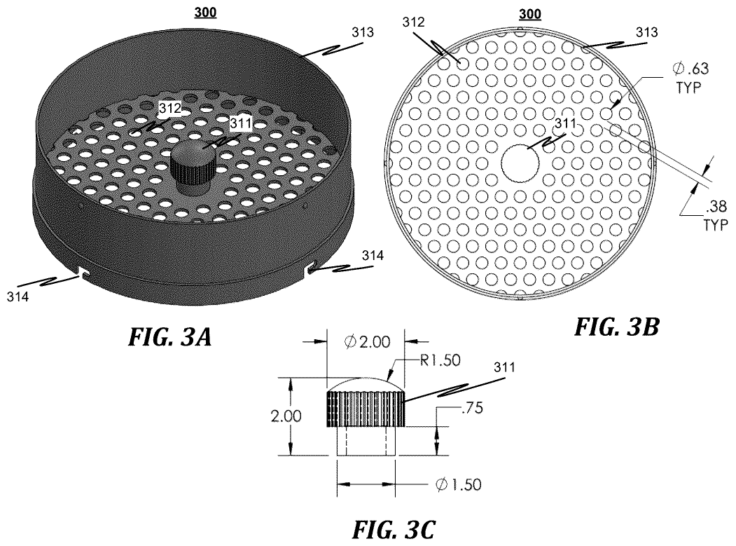

FIG. 3A illustrates an isometric view of a sifter bin assembly 300 according to the disclosed embodiments according to the disclosed embodiments.

Referring to FIG. 3A, the sifter bin 300 has a plurality of round holes 312 located on a bottom sheet of the sifter bin 300. The bottom of the sifter bin 300 is surrounded by cylindrical wall 313. A round ring with locks 314 is attached to the lower end of the cylindrical wall 313. A central knob 311 is positioned at the center of the bottom sheet of the sifter bin 300.

FIG. 3B illustrates a illustrates a top view of the sifter bin assembly 300 according to the disclosed embodiments.

Referring to FIG. 3B, the plurality of round holes 312 is located on a bottom sheet of the sifter bin 300 surrounded by the cylindrical wall 313. The central knob 311 is positioned at the center of the bottom sheet of the sifter bin 300. The sifter bin 300 assembly may have, but not limited to, dimensions depicted in FIG. 3B.

FIG. 3C illustrates a side view of a central knob of the sifter bin assembly 300 according to some embodiments. Referring to FIG. 3C, the central knob 311 may have, but not limited to, dimensions depicted in FIG. 3C.

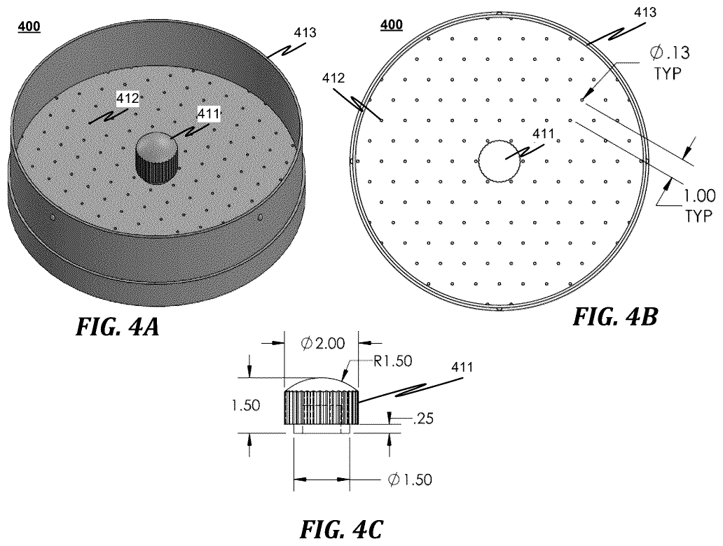

FIG. 4A illustrates an isometric view of a sifter bin assembly 400 according to the disclosed embodiments according to the disclosed embodiments.

Referring to FIG. 4A, the sifter bin 400 has a plurality of round holes 412 located on a bottom sheet of the sifter bin 400. The bottom of the sifter bin 400 is surrounded by cylindrical wall 413. A central knob 411 is positioned at the center of the bottom sheet of the sifter bin 400.

FIGS. 4A-B illustrate the base sifter bin that may be placed at the bottom of the stackable sifter bins'assembly. This sifter bin 400 does not allow anything more to filter through. The holes 412 are strictly for washing purposes and to allow the water to fully drain into the wash bin (or sink) during washing operations. The sifter bin 400 holds the smallest building blocks.

FIG. 4B illustrates a illustrates a top view of the sifter bin assembly 400 according to the disclosed embodiments.

Referring to FIG. 4B, the plurality of round holes 412 is located on a bottom sheet of the sifter bin 400 surrounded by the cylindrical wall 413. The central knob 411 is positioned at the center of the bottom sheet of the sifter bin 400. The sifter bin 400 assembly may have, but not limited to, dimensions depicted in FIG. 4B.

FIG. 4C illustrates a side view of a central knob of the sifter bin assembly 400 according to some embodiments. Referring to FIG. 4C, the central knob 411 may have, but not limited to, demotions depicted in FIG. 4C.

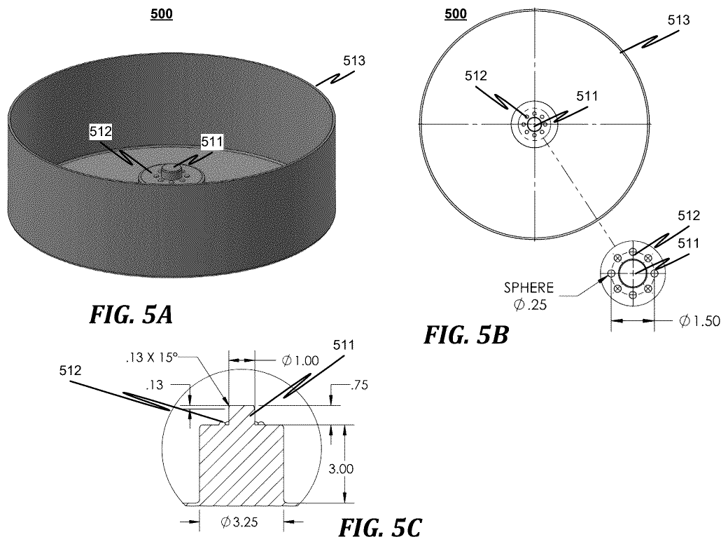

FIG. 5A illustrates an isometric view of a wash bin assembly 500 according to the disclosed embodiments according to the disclosed embodiments.

Referring to FIG. 5A, the bottom sheet of the wash bin 500 is surrounded by cylindrical wall 513. A central plastic ball bearins 512 attached to the central axel 511 positioned at the center of the bottom sheet of the wash bin 500.

FIG. 5B illustrates a illustrates a top view of the sifter bin assembly 500 according to the disclosed embodiments. The sifter bin 500 assembly may have, but not limited to, dimensions depicted in FIG. 5B.

FIGS. 5A-B illustrate the wash bin 500 implementation. The wash bin 500 is configured to hold any of the sifting bins 100-400 individually or if they are all stacked and locked together during washing operations. This wash bin allows the sifting bins 100-400 to be raised off of the bottom of the bin approximately 3 inches allowing the water to drain through the sifting bin(s) 100-400 and into the 3-inch void below. The dirty water is separated from the building blocks or material above allowing them to become clean and dry. The axel 511 provides the locking mechanism for each of the sifting bins 100-400 stacked or individually. Each sifting bin has a void just over the size of the axel 511 size allowing the bin to slide overtop the of 511. This keeps the sifting bin(s) in place and elevated for when the spin operation occurs. This also keeps the sifting bins from moving side to side as only a circular motion is allowed. The in-place elevated plastic ball bearings 512 facilitate smooth spinning of the sifting bins inside the wash bin 500. The plastic ball bearings 512 are implemented as little in-place spheres allowing the sifting bin, when rested in the wash bin, to have very little friction (touch points) on the sifting bin itself during spinning/drying operations. The plastic ball bearings 512 may be made of the same type of material as the wash bin 500.

FIG. 5C illustrates a side view of an axel and plastic ball bearings of the wash bin assembly 500 according to some embodiments. Referring to FIG. 5C, the plastic ball bearings 512 and the axel 511 may have, but not limited to, demotions depicted in FIG. 5C.

Note the sifter bins'assembly may have a top implemented as flat lead cover having a hole and the knob (not shown). The disclosed storage and washing sifter bins'assembly of the stacked sifter bins may have the lead cover with the knob configured to seal the top and to grip the top to enable the stacked sifter bins to spin for continued washing.

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

It will be appreciated by persons skilled in the art that the present embodiment is not limited to what has been particularly shown and described hereinabove. A variety of modifications and variations are possible in light of the above teachings without departing from the following claims.

What is claimed is:

1. A washable sifter bin device comprising:
a circular bottom sheet having a plurality of circular holes;
a cylindrical wall surrounding the circular bottom sheet; and
a central knob attached to the bottom sheet and located at a center of the bottom sheet.

2. The washable sifter bin device of claim 1, further comprising a ring attached to a bottom end of the cylindrical wall.

3. The washable sifter bin device of claim 2, wherein the ring attached to the bottom end of the cylindrical wall comprises a plurality of hooks configure to attach the washable sifter bin device to another sifter bin device.

4. The washable sifter bin device of claim 1, further comprising a top comprising a flat lead cover having a hole and the knob.

5. The washable sifter bin device of claim 4, wherein the knob is configured to seal the top and to grip the top to enable the sifter bins to spin for continued washing.

6. A storage and washing sifter bins'assembly comprising:
a plurality of washable sifter bins attachably stocked to one another, wherein each of the plurality of the washable sifter bins comprises:
a circular bottom sheet having a plurality of circular holes of a particular diameter specified for each of the plurality of the washable sifter bins;
a cylindrical wall surrounding the circular bottom sheet; and
a central knob attached to the bottom sheet and located at a center of the bottom sheet.

7. The storage and washing sifter bins'assembly of claim 6, wherein each of the plurality of the washable sifter bins comprises a ring attached to a bottom end of the cylindrical wall.

8. The storage and washing sifter bins'assembly of claim 7, wherein the ring attached to a bottom end of the cylindrical wall comprises a plurality of hooks configure to attach each of the plurality of the washable sifter bins to each other.

9. The storage and washing sifter bins'assembly of claim 6, further comprising a top comprising a flat lead cover having a hole and the knob.

10. The storage and washing sifter bins'assembly of claim 9, wherein the knob is configured to seal the top and to grip the top to enable the sifter bins to spin for continued washing.

11. The storage and washing sifter bins'assembly of claim 6, further comprising a wash bin configured to accommodate individual washable sifter bins or the plurality of washable sifter bins attachably stocked to one another.

12. The storage and washing sifter bins'assembly of claim 11, wherein the wash bin comprises a central axel with plastic ball bearings positioned around the central axel for facilitation of spinning of the accommodated individual washable sifter bins or the plurality of washable sifter bins attachably stocked to one another inside the wash bin.

13. The storage and washing sifter bins'assembly of claim 11, wherein the central axel is configured for attachment of the individual washable sifter bins or the plurality of washable sifter bins attachably stocked to one another.
